(19) United States
(12) Patent Application Publication
(10) Pub. No.: US 2021/0382234 A1
(43) Pub. Date: Dec. 9, 2021

(54) CABLE JACKET CUTTING TOOL

(71) Applicant: COMMSCOPE TECHNOLOGIES LLC, Hickory, NC (US)

(72) Inventors: Norin P. PAUSAN, St. Asaph (GB); David John WALKER, Runcorn, Cheshire (GB); Amjed ABBAS, Birkenhead, Wirral (GB); Michael LIVESEY, Meliden, Denbighshire (GB); Luke Alec HARDY, Rhyl, Denbighshire (GB); Eric Lydia Paul PEETERS, Heverlee (BE); Nico ROELANDTS, Herent (BE)

(73) Assignee: COMMSCOPE TECHNOLOGIES LLC, Hickory, NC (US)

(21) Appl. No.: 17/287,763

(22) PCT Filed: Oct. 21, 2019
(86) PCT No.: PCT/US2019/057190

§ 371 Date: Apr. 22, 2021

Related U.S. Application Data
(60) Provisional application No. 62/748,893, filed on Oct. 22, 2018.
(60) Provisional application No. 62/843,903, filed on May 6, 2019.

(51) Int. Cl. G02B 6/245

(52) U.S. Cl. CPC G02B 6/245

(57) ABSTRACT

A cutting tool includes a cutting head integrated into a handle. The cutting tool can be used to make a window cut in a cable jacket by sliding the cutting tool along the cable jacket. The cutting tool includes guide surfaces to control the cutting depth into the jacket and to maintain the blade edge at a predetermined depth until the end of the stroke. The cutting tool also may direct a scrap portion of the jacket out of the cutting tool away from the cable. The blade of the cutting head is angled relative to a cable guide channel and is easily replaceable.

### CROSS-REFERENCE TO RELATED APPLICATIONS

This application is being filed on Oct. 21, 2019 as a PCT International Patent Application and claims the benefit of U.S. Patent Application Ser. No. 62/748,893, filed on Oct. 22, 2018, and claims the benefit of U.S. Patent Application Ser. No. 62/843,903, filed on May 6, 2019, the disclosures of which are incorporated herein by reference in their entireties.

### BACKGROUND

Fiber optic telecommunications technology is becoming more prevalent as service providers strive to deliver higher bandwidth communication capabilities to customers/subscribers. As data transmissions increase, the fiber optic network is being extended closer to the end user which can be a premise, business, or a private residence.

As telecommunication cables are routed across data networks, it is necessary to periodically open the cable so that one or more telecommunication lines therein may be spliced, thereby allowing data to be distributed to other cables or “branches” of the telecommunication network. At each point where a telecommunication cable is opened, it is necessary to provide a telecommunications enclosure to protect the exposed interior of the cable. The cable branches may be further distributed until the network reaches individual homes, businesses, offices, and so on. These networks are often referred to as fiber to the premise (FTTP) or fiber to the home (FTTH) networks. In an FTTH network, fiber optic cable is run from the service provider's central office to an ONT located at the subscriber's residence or office space.

Improvements in telecommunications enclosures to protect the exposed interior of fiber optic cables are desirable.

### SUMMARY

Features of the present disclosure relate to a fiber distribution system in which pairs of windows are cut into a distribution cable at various points along the length to couple some of the optical fibers of the distribution cable to drop cables. Select fibers are cut at the first window and retracted through the second window.

In accordance with some aspects of the disclosure, a cutting tool for making a window cut within a jacket of a telecommunications cable includes a handle, a cutting head, and a blade. The cutting head defines a first cable-receiving channel. The cutting head also defines first, second and third guide surfaces positioned within the first cable receiving channel. The guide surfaces face generally downwardly. The third guide surface is positioned between the first and second guide surfaces. The first guide surface angles upwardly from the third guide surface as the first guide surface extends away from the third guide surface and toward one end of the handle. The second guide surface angles upwardly from the third guide surface as the second guide surface extends away from the third guide surface and away from the end of the handle. The blade mounts within the first cable-receiving channel. The blade is oriented parallel to an angular orientation of the third guide surface when the blade is mounted at the blade mounting location.

In certain examples, the blade mounts at a blade mounting location positioned adjacent the third guide surface.

The handle has a first handle end at the cutting head and a second handle end opposite the cutting head. A cutting edge of the blade faces generally toward the second handle end when the blade is mounted at the blade mounting location.

In certain examples, a second cable-receiving channel is disposed at (e.g., defined by) the second handle end.

In certain examples, the first cable-receiving channel, the second cable-receiving channel and the handle are bisected by a common reference plane.

In certain examples, the second cable-receiving channel includes a cable contact surface that aligns with the first guide surface.

In certain examples, the cutting edge of the blade is positioned relative to the first guide surface such that the first guide surface controls a cutting depth of the cutting edge into the jacket of the cable.

In accordance with other aspects of the disclosure, a method for using the cutting tool includes moving the blade into the cable jacket until the first guide surface contacts the cable jacket such that the first guide surface controls a cutting depth of an initial entrance cut the blade into the cable jacket; after the blade is initially moved into the jacket to the cutting depth corresponding to the initial entrance cut, pivoting the handle away from the cable to bring the third guide surface into a parallel, contacting relationship relative to the cable jacket; once the third guide surface is in the parallel, contacting relationship with respect to the cable jacket, sliding the cutting tool straight along the cable such that the blade makes a widow cut along a section of the cable jacket; and once the window cut has been made, further pivoting the handle away from the cable jacket such that the blade makes an exit cut from the cable jacket.

In certain examples, a first sealing arrangement seals the first window of each pair. A second sealing arrangement seals the second window of each pair. The second sealing arrangement also manages the cut optical fibers to enable the cut optical fibers to be optically coupled to one or more drop cables.

Other aspects of the disclosure are directed to a cutting tool for making a window cut within a jacket of a cable. The cutting tool includes a body defining a cable guide channel extending between a front and a rear of the body. The body carries a blade at a fixed angle and a fixed height relative to the cable guide channel. The cable guide channel has a first section extending from the blade to the front of the body and a second section extending from the blade to the rear of the body. The first section is substantially larger than the second section.

Other aspects of the disclosure are directed to a guide tool for making a window cut within a jacket of a cable. The guide tool includes a platform section disposed between two base sections. The platform section includes a guide channel. Each base section includes a retention member. The platform section is disposed sufficiently far above the base section and sufficiently far from the retention members to bend a cable received at the body along a preferred cutting path.

These and other features and advantages will be apparent from a reading of the following detailed description and a review of the associated drawings. A variety of additional aspects will be set forth in the description that follows. These aspects can relate to individual features and to combinations of features. It is to be understood that both the foregoing general description and the following detailed description are exemplary and explanatory only and are not restrictive of the broad concepts upon which the embodiments disclosed herein are based.

### BRIEF DESCRIPTION OF THE DRAWINGS

FIG. 1 is a schematic representation of a fiber optic network including a cable passing through an optical termination enclosure, the cable having an incision in accord with principles of the present disclosure.

FIG. 2 is a schematic representation of the fiber optic network shown in FIG. 1 with an optical fiber retracted from the cable and an enclosure arrangement positioned over the incision in accord with the principles of the present disclosure.

FIG. 3 is a perspective view of an example cutting tool suitable for use in making a window cut in a jacket of a cable, the tool including a handle, a cutting head, and a blade.

FIG. 4 is a perspective view of the cutting tool of FIG. 3 with the blade exploded from the cutting head.

FIG. 5 is an end view of the cutting tool of FIG. 3.

FIG. 6 is a cross-sectional view of the cutting tool of FIG. 3 taken along the 6-6 line of FIG. 5.

FIG. 7 illustrates using the cutting tool of FIG. 3 to make an initial cut into the jacket of a cable.

FIG. 8 illustrates using the cutting tool of FIG. 3 to make a window cut into the jacket of the cable of FIG. 7.

FIG. 9 illustrates using the cutting tool of FIG. 3 to make an exit cut out of the jacket of the cable.

FIG. 10 illustrates an example window cut into a cable using the cutting tool of FIG. 3.

FIG. 11 illustrates an example cable including a plurality of fibers surrounded by a jacket with strength members embedded within the jacket and axial protrusions on the jacket indicating the location of the strength members.

FIG. 12 is a perspective view of an example guide tool for use in making a window cut into a jacket of a cable.

FIG. 13 shows a cable mounted at the guide tool of FIG. 12;

FIG. 14 is a cross-sectional view of the cable and guide tool of FIG. 13.

FIG. 15 is a transverse cross-sectional view taken along the 15-15 line of FIG. 14.

FIG. 16 is a transverse cross-sectional view taken along the 16-16 line of FIG. 14.

FIG. 17 shows an example cutting tool mid-stroke over the cable of FIG. 13.

FIG. 18 shows the window cut made in the cable of FIG. 13.

FIG. 19 illustrates example ramp members installed at the guide tool of FIG. 12.

FIG. 20 is a perspective view of an example ramp member suitable for use with the guide tool of FIG. 19.

FIG. 21 is a side elevational view of the guide tool and ramp member of FIG. 19 with a cable installed thereon and a cutting tool mid-stroke over the cable.

FIG. 22 shows the window cut made in the cable of FIG. 21.

FIG. 23 is a top perspective view of another example cutting tool for use in making a window cut in a cable.

FIG. 24 is a bottom perspective view of the cutting tool of FIG. 23.

FIG. 25 is an exploded view of the cutting tool of FIG. 23.

FIG. 26 is a longitudinal cross-sectional view of the cutting tool of FIG. 23 with the blade, fasteners, and nuts removed for use in viewing.

FIG. 27 is an enlarged view of a portion of FIG. 26.

FIG. 28 is a perspective view of a longitudinal cross-section taken of the cutting tool of FIG. 23 with the blade, fasteners, and nuts removed for use in viewing.

FIG. 29 is a rear perspective view of the cutting tool of FIG. 23.

FIG. 30 is a longitudinal cross-sectional view of the cutting tool of FIG. 23.

FIG. 31 is an enlarged view of a portion of FIG. 30.

### DETAILED DESCRIPTION

A feature of the present disclosure relates to an enclosure arrangement for resealing an opening in an optical cable.

When expanding an optical network into a new neighborhood or other location, one or more distribution cables 12 can be routed through the neighborhood. One or more fibers are broken out from a distribution cable 12 at various points along the route to provide service to subscribers. The broken out fibers can be optically coupled to drop cables 13, which are routed to the subscribers. For example, the broken out fibers can be coupled to the drop cables 13 at an optical terminal enclosure (OTE).

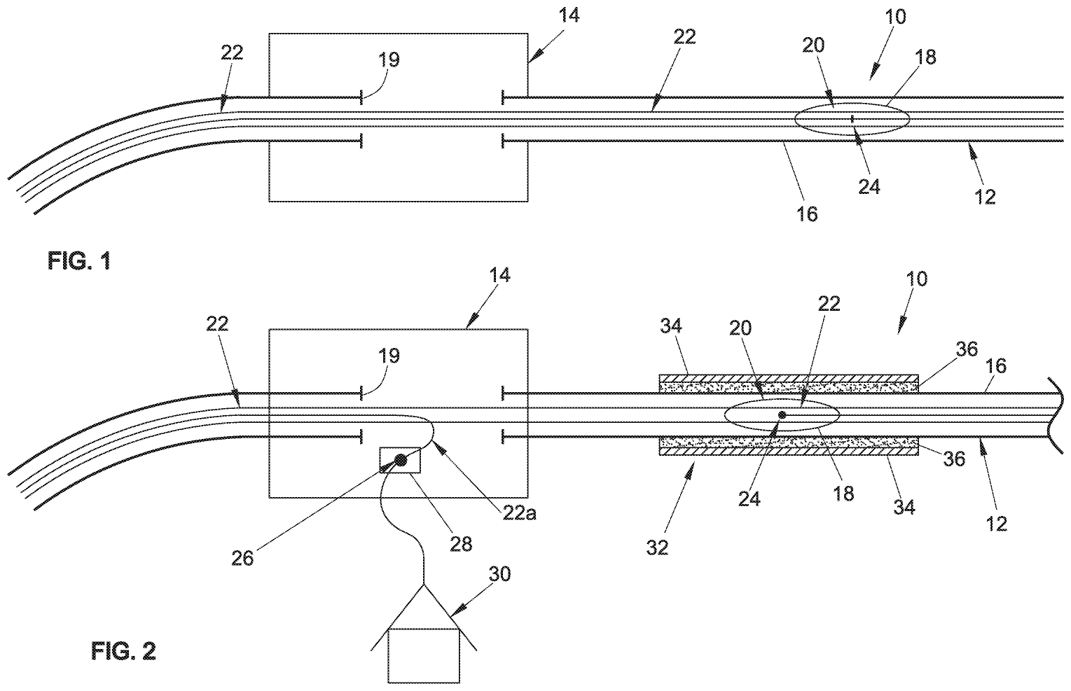

FIGS. 1 and 2 illustrate a portion of a fiber optic network 10 in accordance with the principles of the present disclosure. In such an embodiment, a telecommunications cable 12 (e.g., a single fiber or multi-fiber distribution cable) is shown passing through an example OTE 14. The telecommunications cable 12 may have on the order of twelve to forty-eight fibers 22; however, alternative implementations may include fewer or more fibers. While telecommunications cables typically have a large number of fibers 22, the various aspects of the present disclosure are also applicable to distribution cables having fewer numbers of fibers 22 (e.g., 2 or more fibers).

In certain examples, the telecommunications cable 12 can include an outer jacket 16 enclosing a single buffer tube 15 and at least two strength members extending on opposite sides of the single buffer tube. An outer strength member 11 such as Kevlar can surround the single buffer tube 15 within the jacket 16. The single buffer tube 15 can enclose loose fibers or ribbon fibers. In other examples, the fibers 22 can be loose within the outer jacket 16. In other examples, the cable 12 can include a single strength member.

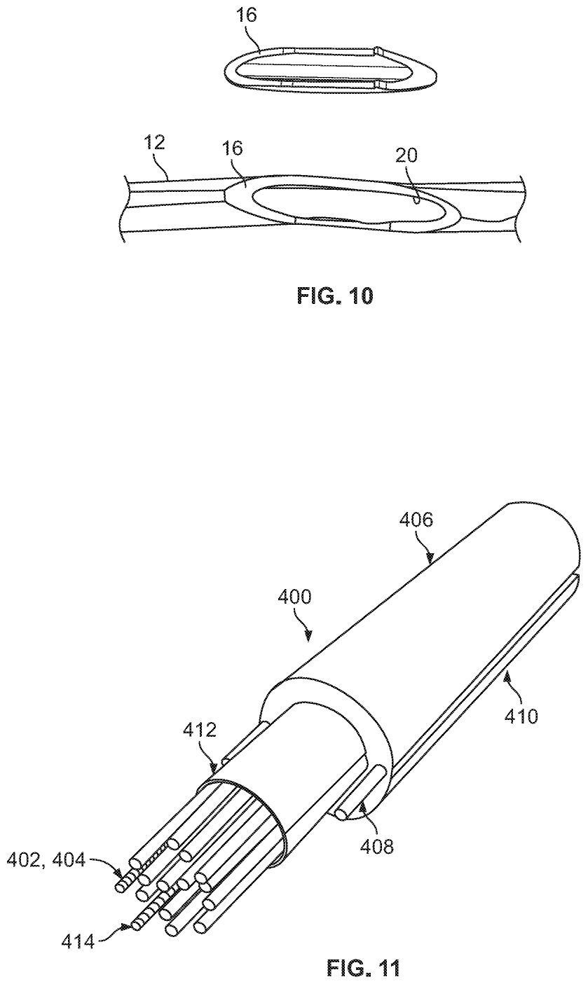

An incision 18 (e.g., cut) can be made in the outer jacket 16 of the telecommunications cable 12 such that a portion of the outer jacket 16 may be removed from the telecommunications cable 12 that is outside the OTE 14 to provide a window 20 (i.e., opening) that exposes optical fibers 22. An example tool 300 and process for cutting the window 20 into the outer jacket 16 are described herein with reference to FIGS. 3-10. One or more of the optical fibers 22 of the telecommunications cable 12 may be cut at a location 24 aligned with the window 20.

The cut optical fiber 22a (FIG. 2) may be retracted out of the telecommunications cable 12 while the remaining optical fibers 22 of the telecommunications cable 12 are uncut and continue to pass through. For example, a second incision can be made in the outer jacket 16 such that a portion of the outer jacket 16 may be removed to provide a second window 19. The cut optical fiber 22a can be retracted out of the cable 12 through the second window 19.

The OTE 14 is mounted over the second window 19 to seal the second window 19. The cut optical fibers 22a retracted out of the cable 12 are protected and managed within the OTE 14. For example, the OTE 14 can include a splice tray 28, optical adapters, and/or an optical splitter to which the cut optical fibers 22a can be optically coupled. In certain examples, the cut optical fibers 22a can be spliced at a splice location 26 within splice tray 28 for facilitating coupling of the cut optical fiber 22a to a subscriber location 30. In other examples, the cut optical fiber 22a can be routed directly to the subscriber location 30 and spliced there rather than within the OTE 14.

The OTE 14 is configured to be mounted vertically to a wall or other surface so that the distribution cable 12 extends generally horizontally across the OTE 14. The distribution cable 12 may extend across many buildings or other structures. Multiple sets of first and second windows 18, 19 may be cut into the cable 12 and multiple OTEs 14 may be disposed along the cable 12 at the second windows 19. One or more drop cables 13 extend out from each OTE 14 towards subscribers. In certain implementations, the drop cables 13 may extend generally upwardly (e.g., vertically) towards the subscribers. In certain implementations, the drop cables 13 are routed towards the distribution cable 12 and then run along the distribution cable 12 (e.g., wrapped around the cable 12 or secured to the cable 12) over a distance towards the subscribers.

A sealing arrangement 32 is mounted over the first window 18 to environmentally seal the telecommunications cable 12. The distance between the OTE 14 and the sealing arrangement 32 can be from about 2 meters up to about 100 meters. The distance can vary with the length of the telecommunications cable 12 and the required distance to be routed. The distance can also depend on the path of travel whether it is a straight path or a path with many turns. The location of the incision or cut will also be a factor in addition to the friction of the cable.

FIGS. 3-10 illustrate an example cutting tool 300 and process for cutting the window 20 into the outer jacket 16 of a cable 12. The cutting tool 300 includes a handle 310, a cutting head 312, and a blade 314.

The handle 310 has a handle length LH that extends between a first handle end 316 and an opposite second handle end 318 (see FIG. 6). In certain examples, the handle 310 includes gripping structure that facilitates grasping of the handle 310 by a user. For example, the handle 310 may define finger slots 311 sized and shaped to receive fingers of a user when the user grasps the handle 310. In other examples, the handle 310 may include a textured surface, a tacky surface, a deformable surface, finger holds, or gripping structures.

The cutting head 312 is disposed at the first end 316 of the handle 310. In certain examples, the cutting head 312 is integrated (i.e., monolithically formed) with the first end 316 of the handle 310. The cutting head 312 defines a first cable-receiving channel 320 having an open side 322 that faces downwardly away from the handle 310. The first cable-receiving channel 320 has a channel length that extends along a channel axis between open first and second opposite channel ends 324, 326 of the first cable-receiving channel 320. The channel length extends in an orientation along the handle length LH with the first channel end 324 being closer to the second handle end 318 than the second channel end 326.

The cutting head 312 includes first, second and third guide surfaces 328, 330, 332 positioned within the first cable-receiving channel 320 that face generally downwardly. The first guide surface 328 is positioned adjacent the first channel end 324, the second guide surface 330 is positioned adjacent the second channel end 326, and the third guide surface 332 is positioned between the first and second guide surfaces 328, 330. The first guide surface 328 angles upwardly from the third guide surface 332 as the first guide surface 328 extends away from the third guide surface 332 and toward the second handle end 318. The second guide surface 330 angles upwardly from the third guide surface 332 as the second guide surface 330 extends away from the third guide surface 332 and away from the second handle end 318.

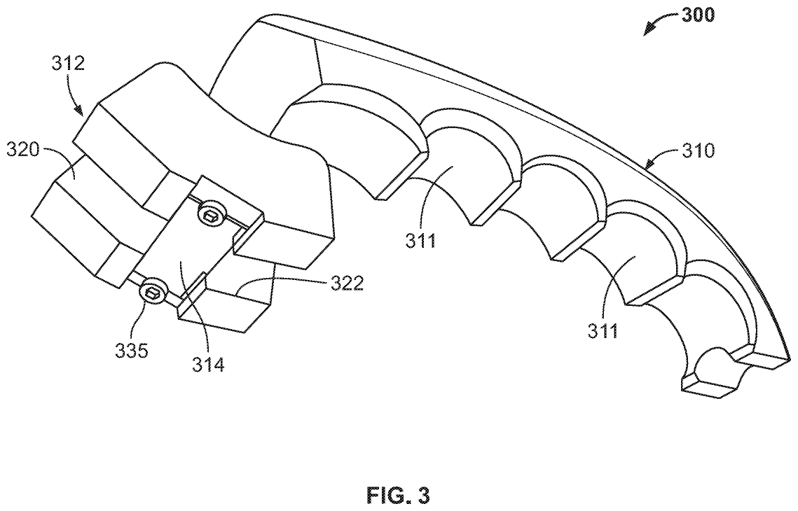

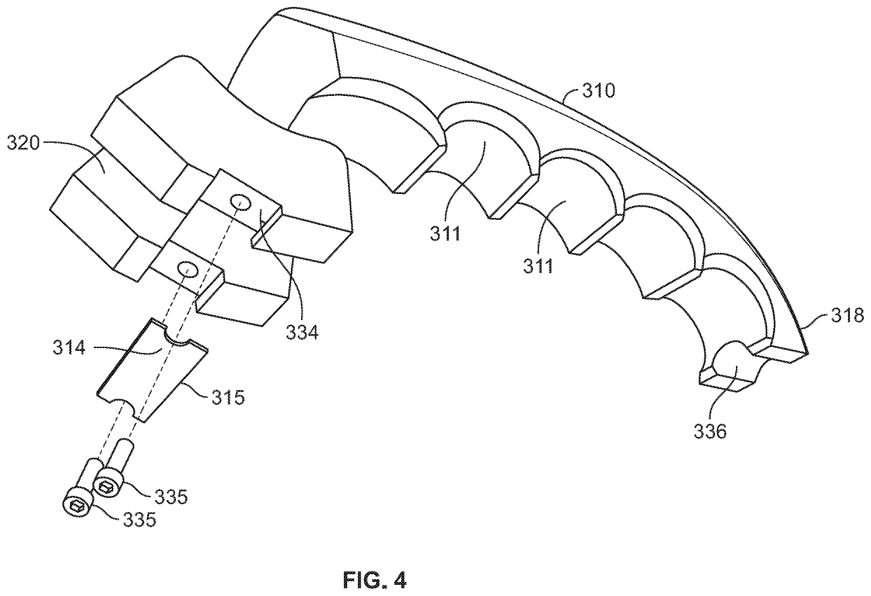

The blade 314 mounts within the first cable-receiving channel 320 at a blade mounting location 334 positioned adjacent the third guide surface 332. In certain examples, the blade 314 is removable from the cutting head 312 to enable replacement of the blade 314. In an example, the blade 314 is held at the blade mounting location 334 using screws 335 or other such fasteners (e.g., see FIG. 4). In other examples, the blade 314 can be snap-fit, friction fit, press-fit, glued, or otherwise held at the blade mounting location 334.

The blade 314 is positioned so that a cutting edge 315 of the blade 314 is disposed within the first cable-receiving channel 320. The cutting edge 315 of the blade 314 is positioned relative to the first guide surface 328 such that the first guide surface 328 controls a cutting depth of the cutting edge 315 into the jacket 16 of the cable 12. The blade 314 is oriented parallel to an angular orientation of the third guide surface 332 when the blade 314 is mounted at the blade mounting location 334. The cutting edge 315 of the blade 314 faces generally toward the second handle end 318 when the blade 314 is mounted at the blade mounting location 334.

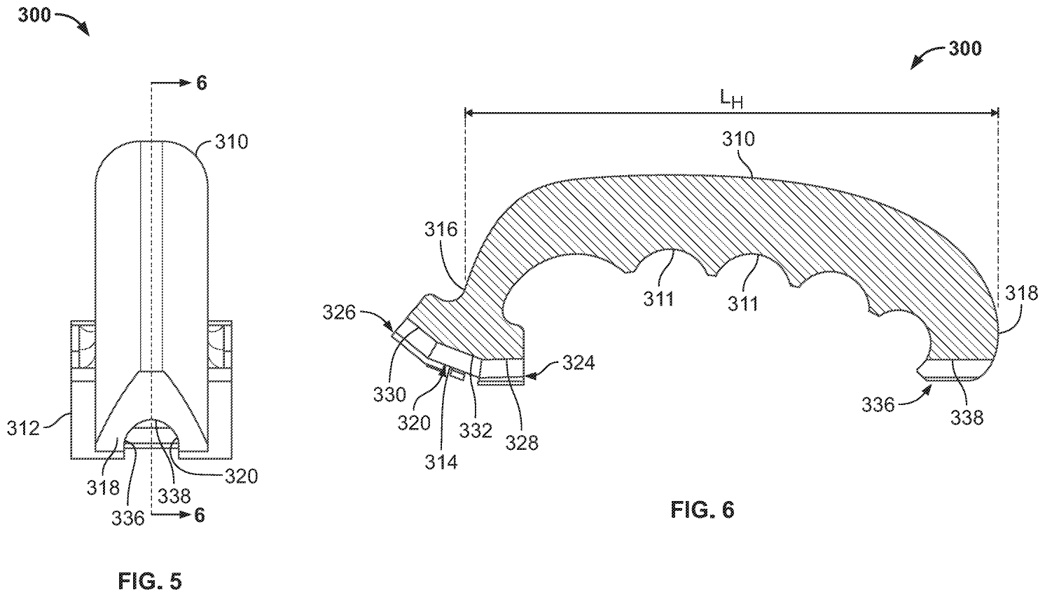

A second cable-receiving channel 336 is integrated with the second handle end 318 of the handle 310. In certain implementations, the second cable-receiving channel 336 aligns with the first cable-receiving channel 320. In certain implementations, the first cable-receiving channel 320, the second cable-receiving channel 336, and the handle 310 are bisected by a common reference plane A (see FIG. 5).

The second cable-receiving channel 336 includes a cable contact surface 338 that aligns with the first guide surface 328. The second cable-receiving channel 336 has an open side that faces downwardly away from the handle. The open side leads to the cable contact surface 338. The second cable-receiving channel 336 has a channel length that extends along a channel axis between open first and second opposite channel ends of the second cable-receiving channel 336. The channel length extends in an orientation along the handle length LH with the first channel end being further from the first handle end 316 than the second channel end.

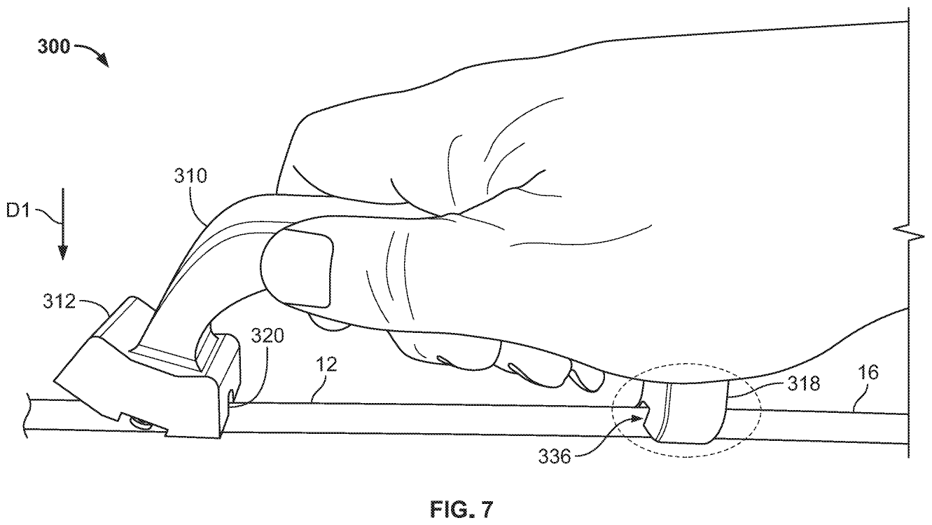

In use, a user grasps the cutting tool 300 by the handle 310 and aligns the cable 12 with the first cable-receiving channel 320 of the cutting head 312. The user moves a cutting edge 315 of the blade 314 into the cable jacket 16 until the first guide surface 328 of the cutting head 312 contacts the cable jacket 16. For example, the user moves the tool 300 along a direction D1 (e.g., see FIG. 7) to dig the cutting edge 315 into the jacket 16. The first guide surface 328 controls a cutting depth of an initial entrance cut of the blade 314 into the cable jacket 16. In some examples, the user pulls the cutting tool 300 a short distance along the longitudinal axis of the cable 12 to dig the blade edge 315 into the jacket 16. In other examples, pressing the cable 12 into the first cable-receiving channel 320 is sufficient to dig the blade edge 315 into the jacket 16.

In certain implementations, the user also places the second handle end 318 of the handle 310 onto the cable 12 so that the cable jacket 16 seats against the cable contact surface 338 of the second cable-receiving channel 336 in a parallel, contacting relationship. Pressing the second handle end 318 of the handle 310 against the cable 12 may help to stabilize the cutting head 312 over the portion of the cable 12 into which the window 20 is to be cut. For example, the user may push against an intermediate portion (e.g., a central portion) of the handle 310 to press both the first guide surface 328 and the cable contact surface 338 against the cable jacket 16.

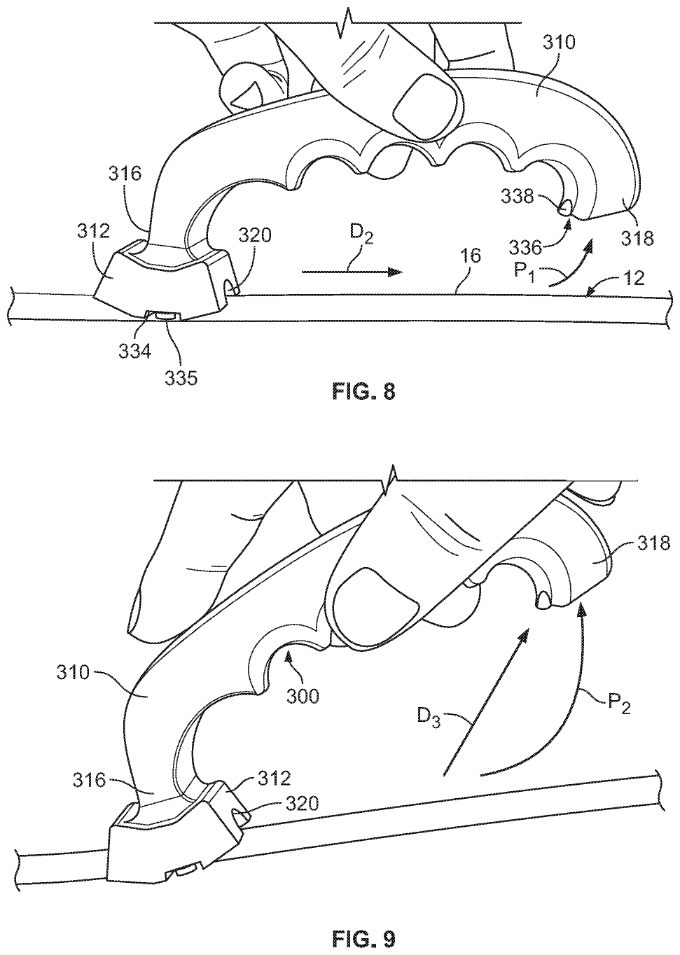

After the blade 314 is initially moved into the jacket 316 to the cutting depth corresponding to the initial entrance cut, the user pivots the second handle end 318 of the handle 314 off and away from the cable 12 along a pivot path P1 (e.g., see FIG. 8). Pivoting the second handle end 318 away from the cable 12 repositions the cutting head 312 relative to the cable 12. The third guide surface 332 of the first cable-receiving channel 320 is brought into a parallel, contacting relationship with the cable jacket 16. Repositioning the cutting head 312 so that the third guide surface 332 contacts the cable jacket 16 aligns the cutting edge 315 of the blade 314 to cut along a longitudinal axis of the cable 12.

Once the third guide surface 332 is in the parallel, contacting relationship with respect to the cable jacket 16, the user slides the cutting tool 300 straight along the cable 12 such that the blade 314 makes a widow cut 20 along a section of the cable jacket 16. For example, the user may pull the cutting tool 300 along a direction D2 that extends generally parallel to the longitudinal axis of the cable 12 (e.g., see FIG. 8).

Once the window cut 20 has been made, the user further pivots the second handle end 318 of the handle 310 away from the cable jacket 16 along a pivot path P2 such that the blade 314 makes an exit cut from the cable jacket 16. In certain examples, the user pivots the handle 310 until the second guide surface 330 of the first cable-receiving channel 320 is brought into a parallel, contacting relationship with the cable jacket 16. The user then lifts the cutting head 312 off the cable 12 (e.g., along a direction D3).

As shown in FIG. 10, the portion of the cable jacket 16 cut from the cable 12 is removed to expose the window cut 20. One or more fibers can then be accessed via the window 20 to enable cutting and retraction of the fiber(s). After one or more of the fibers are accessed via the window 20, a sealing arrangement can be positioned around the window 20 to protect the fibers and the interior of the cable 12. Example sealing arrangements are shown and disclosed in U.S. Provisional Application No. 62/681,923, filed Jul. 7, 2018, and titled “Sealing Enclosure Arrangements for Optical Fiber Cables,” the disclosure of which is hereby incorporated herein by reference in its entirety.

FIG. 11 illustrates an example implementation 400 of the cable 12 in which a window cut 19, 20 may be made. The cable 400 includes a plurality of optical fibers 402 disposed within a jacket 406. The fibers 402 may be grouped within one or more buffer tubes 404 within the jacket 406. In certain examples, the fibers 402 are loosely held within the buffer tubes. In certain examples, the jacket 406 is a slow smoke zero halogen jacket.

In certain implementations, the cable 400 includes one or more strength members 408. In certain examples, the strength members 408 are embedded within the jacket 406. In certain examples, the strength members 408 include fiber glass reinforced plastic (FGRP) rods. In certain implementations, the cable 400 has a generally round transverse cross-section. In certain examples, the strength members are embedded within the jacket 406 within round transverse cross-section of the cable 400.

In certain examples, an axially-extending protrusion 410 indicates a position of each strength member 408 within the jacket 406. For example, each protrusion 410 may extend parallel with a respective strength member 408. Each protrusion 410 has a transverse cross-dimension that is smaller than a transverse cross-dimension of the respective strength member 408.

In certain examples, a water swellable tape 412 may be disposed between the fibers 402 (or buffer tubes 404) and the jacket 406. For example, a sheet of tape 412 may be wrapped around a group of buffer tubes 404. In certain examples, one or more water blocking yarns 414 may be disposed within the cable 400 along the fibers 402 (or buffer tubes 404).

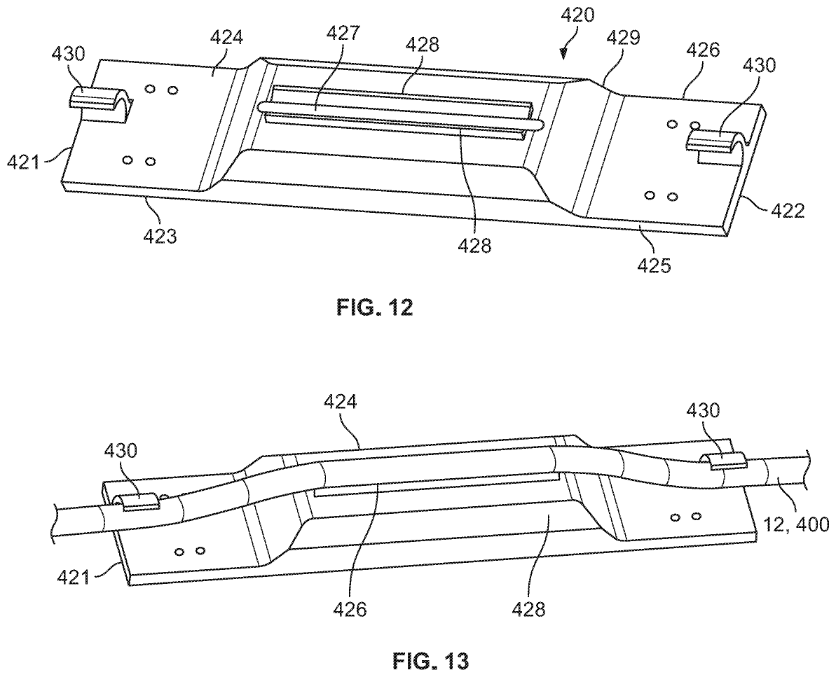

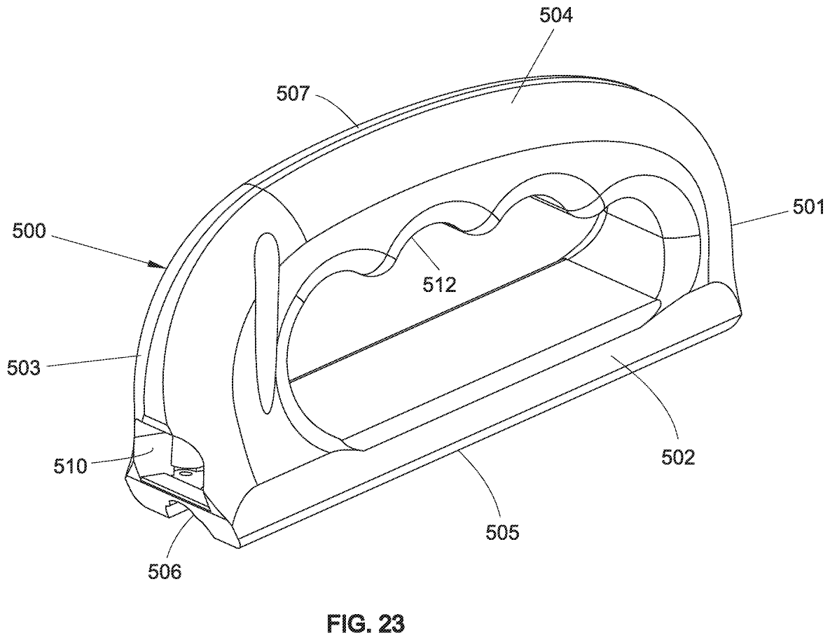

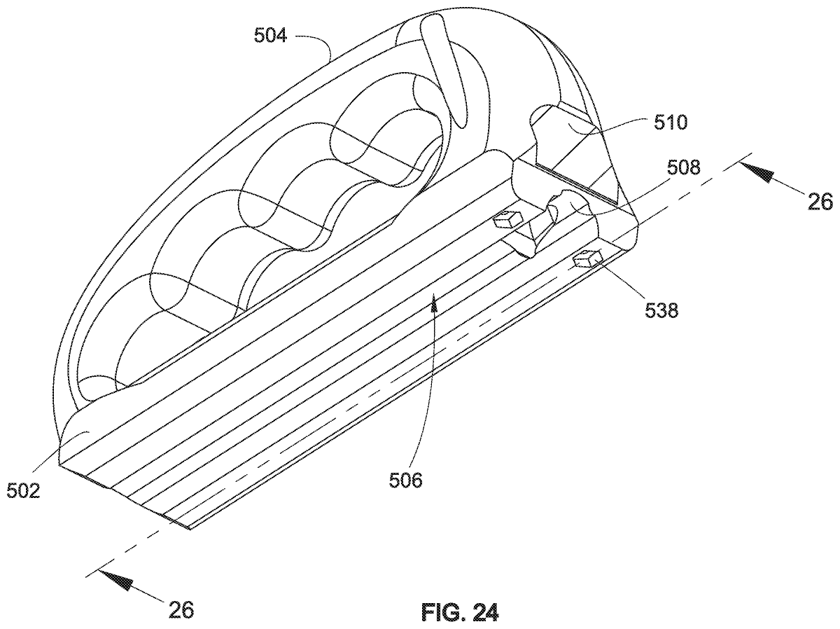

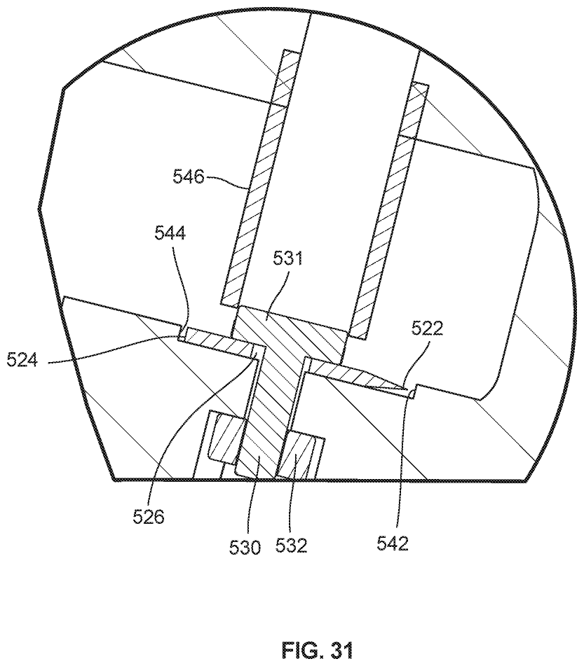

FIGS. 12-22 illustrate a guide tool 420 to facilitate making a window cut 20 in a cable using the cutting tool 300 disclosed above, a cutting tool 500 disclosed herein with reference to FIGS. 23-31, or any desired cutting tool T. The guide tool 420 is configured to position and releasably hold a portion of a cable 12, 400 along a predetermined cutting path to facilitate making a window cut 19, 20 in the cable 12, 400.

For example, the cable 12, 400 is held in position so that holding a cutting tool at a constant orientation relative to the cable and sliding the cutting tool along a straight path will cause a blade of the cutting tool to enter the jacket 406 to a predetermined depth, cut along the jacket 406 a predetermined distance, and exit the jacket 406 at the end of the distance. Advantageously, a user need not worry about adjusting the angle of the cutting tool, monitoring the depth of the blade into the cable, or monitoring an amount of cable jacket cut during the cutting motion. In certain examples, the guide tool 420 also inhibits rotation of the cable 12, 400 while held along the predetermined cutting path.

The guide tool 420 extends along a length between opposite first and second ends 421, 422, along a width between opposite first and second sides 425, 426, and along a depth between an abutment surface 423 and a retaining surface 424. The abutment surface 423 is configured to seat against a wall, duct, raceway, or other surface over which the cable 12, 400 is routed. In certain examples, one or both of the first and second sides 425, 426 are tapered, contoured, or otherwise shaped to facilitate sliding the guide tool 420 between a cable 12, 400 and the surface over which the cable 12, 400 is routed. For example, a user may need to slide the guide tool 420 between a cable and a wall along which the cable is routed. In certain examples, environmental factors (e.g., cold temperatures) may make the cable rigid or otherwise difficult to move.

The retaining surface 424 is configured to receive the portion of the cable 12, 400. The guide tool 420 includes a guide channel 427 extending along part of the length of the guide tool 420. The guide channel 427 is sized to enable a portion of the cable 12, 400 to seat within the channel 427. In certain examples, sidewalls 428 extend along opposite sides of the guide channel 427 to further aid in retaining the cable 12, 400 at the guide channel 427. In certain examples, the sidewalls 428 are sized to not interfere with the axial protrusions 410 of the cable 400. For example, the sidewalls 428 may be sufficient short to enable the protrusions 410 to extend above the sidewalls 428 (e.g., see FIG. 16). In certain examples, top edges of the sidewalls 428 provide a guide surface along which a cutting tool T can be moved in a cutting stroke.

Retention members 430 are disposed at opposite ends of the guide channel 427. Each retention member 430 is configured to hold the cable 12, 400 against the retaining surface 424 of the guide tool 420. In certain examples, each retention member 430 is configured to inhibit rotation of the cable 12, 400 (e.g., as will be described in more detail herein).

In certain examples, positioning the cable 12, 400 along the cutting path facilitates insertion of a blade of a cutting tool into the jacket 406 of the cable 12, 400 at an appropriate entry angle as will be discussed herein. In certain examples, positioning the cable 12, 400 along the cutting path limits a possible length of a cut made into the jacket 406 as will be discussed herein. In certain examples, positioning the cable 12, 400 along the cutting path facilitates removal of a blade from the cable jacket 406 at an appropriate egress angle as will be discussed herein.

In certain implementations, the retention members 430 are configured to quickly and easily receive and release the cable 12, 400. In certain examples, each retention member 430 includes a retaining finger 432 that defines a slot 434 sized to receive the cable 12, 400. The slot 434 is sized to accommodate the transverse cross-dimension (e.g., diameter) of the cable 12, 400. In certain examples, the retaining finger 432 extends upwardly from the retaining surface 424 to define an opening 436 leading to the slot 434. In certain examples, the openings 436 of both retention members 430 face in a common direction. Accordingly, the cable 12, 400 can be slid in a common direction to enter the slots 434 of both retaining fingers 432. The cable 12, 400 is removed from the retention members 430 by sliding the cable 12, 400 out of the slots 434 through the openings 436 in an opposite direction.

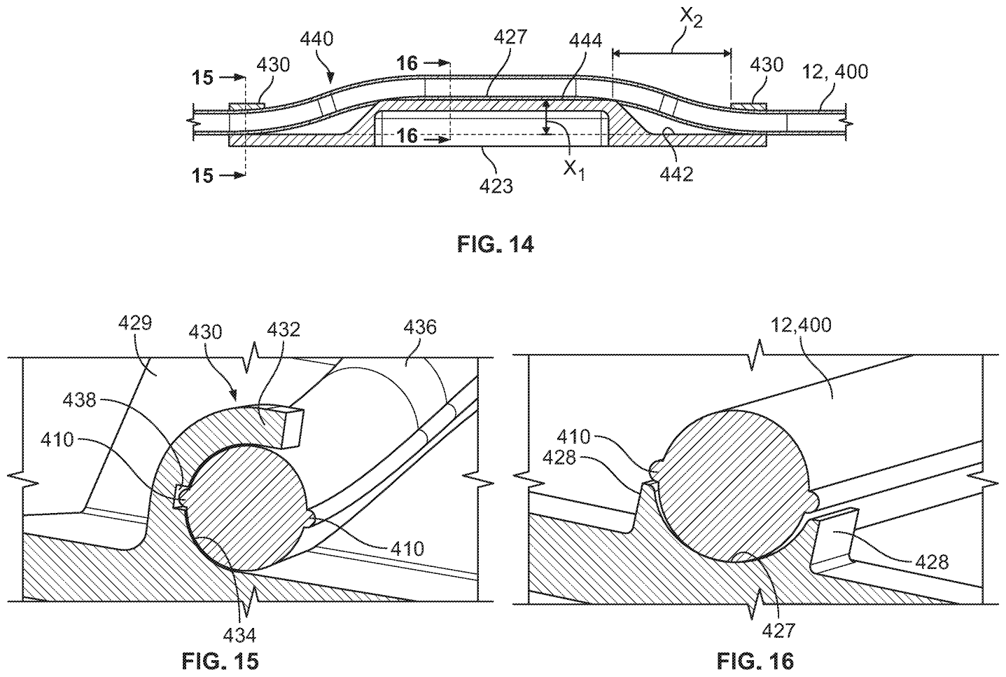

In certain implementations, the retention members 430 are configured to inhibit rotation of the cable 12, 400. For example, each retention member 430 may define a notch 438 sized to receive one of the protrusions 410 of the cable 400 (e.g., see FIG. 15). Engagement between the protrusion 410 and the notch 438 inhibits torqueing of the cable 400. Further, positioning the protrusion 410 in the notch 438 of the opposite retention members 430 inhibits cutting of the strength members 408 during a cutting stroke of a cutting tool T. The notches 438 position the cable 12, 400 so that the strength members 408 are at known locations relative to the guide tool 420. For example, the notches 438 may position the strength members 408 so that neither strength member 408 is disposed within the guide channel 427.

In certain implementations, the retaining surface 424 of the guide tool 420 includes a platform section 444 disposed between two base sections 442. The retention members 430 are each disposed at a respective one of the base sections 442. The guide channel 427 is disposed on the platform section 444. The platform section 444 is disposed at a distance X1 above the base sections 442 (FIG. 14). Axial ends of the platform section 444 are disposed at a distance X 2 away from an adjacent retention member 430.

In certain examples, the distance X1 is at least the transverse cross-dimension (e.g., diameter) of the cable 12, 400. In certain examples, the distance X1 is between the transverse cross-dimension of the cable 12, 400 and twice the transverse cross-dimension of the cable 12, 400. In certain examples, the distance X1 is between 0.25 inches and 1 inch. In certain examples, the distance X1 is between 0.5 inches and 0.75 inches. In an example, the distance is about 0.5 inches. In an example, the distance is about 0.75 inches. In certain examples, the distance X2 is less than a length of the platform section 444. In certain examples, the distance X2 is about the length of the base section 442. In certain examples, the distance X2 is no more than the length of the base section 442.

In certain examples, the axial ends of the platform section 444 are radiused or otherwise contoured to inhibit damage to the cable (e.g., to inhibit the edge from cutting into the cable). In the example shown, a respective transition surface between the platform section 444 and each base section 442 is tapered. In other examples, the transition surfaces may step, contour, or otherwise transition between the platform section 444 and the respective base section 442.

When a cable 12, 400 is routed over the guide tool 420, the cable 12, 400 transitions from a first retention member 430 at a first base section 442, over the platform section 444 (e.g., along the guide channel 427), and back down to a second retention member 430 at a second base section 442. The distances X1 and X2 are selected to inhibit bending of the cable 12, 400 beyond a maximum bend radius. The distances X1 and X2 are selected to bend the cable 12, 400 at the axial ends of the platform section 444 to position the cable 12, 400 along a predetermined cutting path.

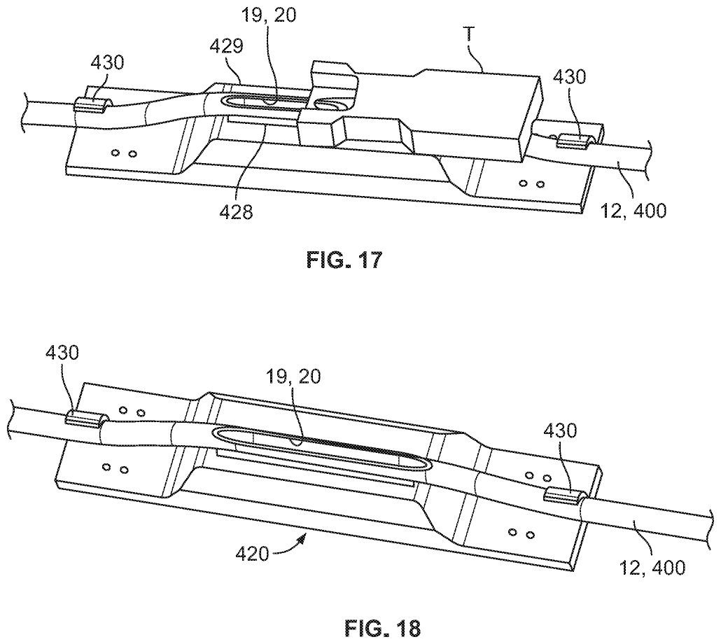

In use, a cable is mounted to the guide tool 420 so that a portion of the cable 12, 400 extends along the guide channel 427 between the two retention members 430. A cutting tool T (e.g., cutting tool 300 or 500) is slid over the cable 12, 400 along the platform section 444 of the guide tool 420 during a cutting stroke (e.g., see FIG. 17). The cutting tool T is maintained in a common orientation through the cutting stroke. Because of how the cable 12, 400 is bent at the first axial edge of the platform section 444, the cable 12, 400 extends at an angle relative to the cutting tool T. Accordingly, sliding the cutting tool T straight across the axial edge of the platform section 444 causes a blade of the cutting tool to cut into the jacket 406 of the cable 12, 400.

However, as the cable 12, 400 flattens out over the platform section 444, the angle between the cable 12, 400 and the cutting tool blade decreases. In certain examples, the edge of the blade becomes parallel or close to parallel with a longitudinal axis of the cable 12, 400. Accordingly, the cutting tool blade is inhibited from cutting into the cable 12, 400 by more than a predetermined depth. Continuing to slide the cutting tool along the platform section 444 (e.g., over the guide channel 427 where the cable 12, 400 is flat), creates a substantially straight cut through the cable jacket 406 at the predetermined depth.

At the opposite end of the platform section 444, the cable 12, 400 transitions down to the second base section 442 and second retention member 430. The bend in the cable 12, 400 as the cable transitions down again changes the angle of the cutting tool blade with respect to the cable 12, 400 without needing any adjustments to the orientation of the cutting tool. As the cutting tool continues to slide along the cable 12, 400 over the second axial end of the platform section 444, the blade angles upwardly relative to the cable 12, 400. Accordingly, continuing to slide the cutting tool T past the second axial end of the platform section 444 causes the blade to exit the cable jacket 406.

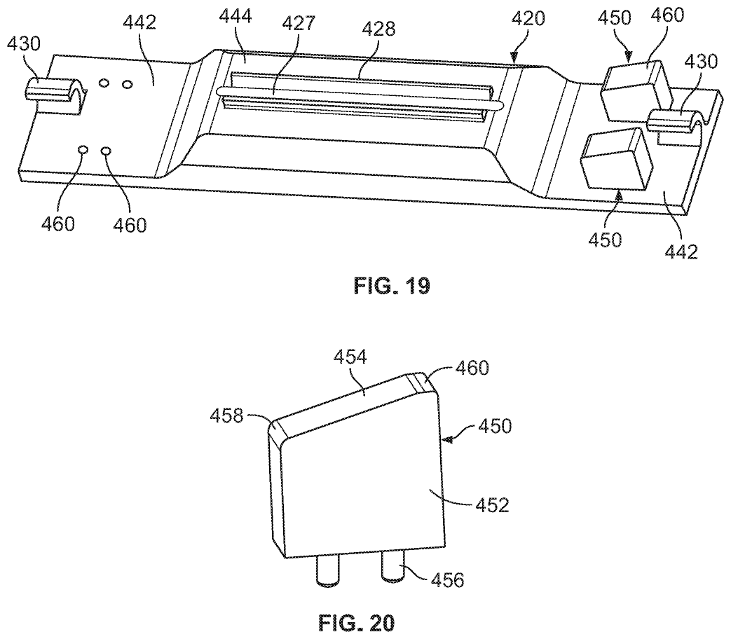

FIGS. 19-22 illustrate a system and method for changing a length of the window cut 19, 20 made into the cable 12, 400 using the guide tool 420. One or more ramp members 450 can be installed on the guide tool 420 to modify the cutting stroke that will be made to the cable 12, 400.

As shown in FIG. 20, each ramp member 450 includes a body 452 having a ramp surface 454. The ramp surface 454 extends between a shorter end 458 and a taller end 460. In certain examples, each ramp member 450 includes mounting structure 456 at an opposite end from the ramp surface 454. In the example shown, the mounting structure 456 includes one or more pegs 456. In other examples, the mounting structure 456 may include holes to receive pegs, latches, fastener openings, or other structures to secure the ramp members 450 to the guide tool 420.

As shown in FIG. 19, one or more ramp members 450 can be mounted at one or both base sections 442 of the guide tool 420. The ramp members 450 are installed with the shorter end 458 facing the platform section 444 and the taller end 460 facing away from the platform section 444. The shorter end 458 is generally the same height as the platform section 444. The taller end 460 is generally taller than the platform section 444.

In certain implementations, the ramp members 450 do not interfere with or otherwise affect the routing of the cable along the guide tool 420. In the example shown, the ramp members 450 are used in pairs. The cable 12, 400 extends between the pair of ramp members 450. In other examples, however, a single ramp member 450 or three or more ramp members 450 may be used. In still other examples, two or more ramp members 450 may be integrally formed and installed as a unit.

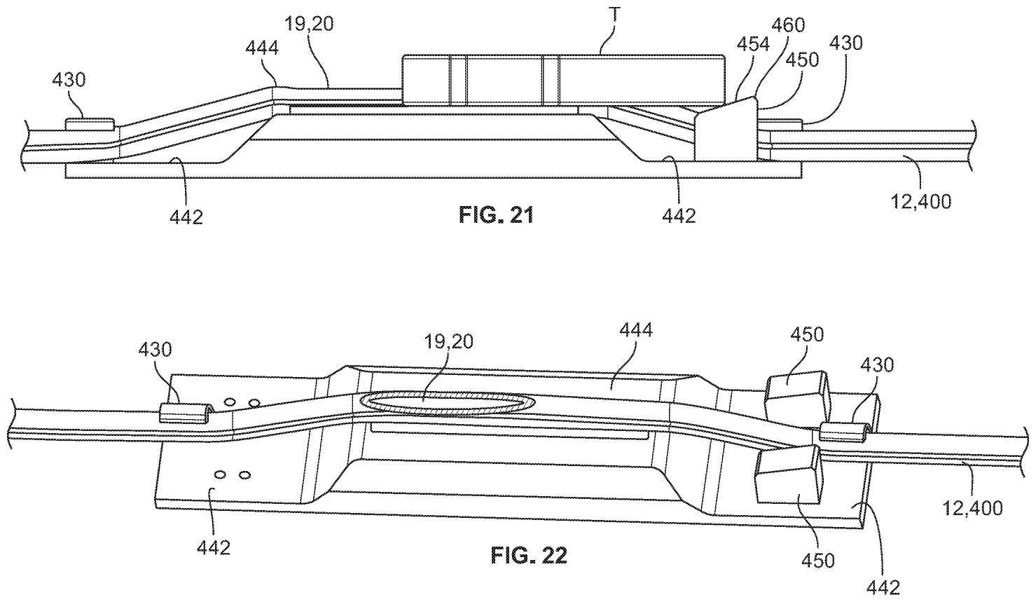

The ramp members 450 are installed at the first base section 442 and/or at the second base section 442 to shorten the length of the window 19, 20 cut into the cable 12, 400. In FIG. 21, the ramp members 450 are shown installed at the second base section 442. Accordingly, making a cutting stroke across the cable 12, 400 with a cutting tool T begins the same as discussed above with respect to FIG. 17. However, when the cutting tool T reaches the ramp members 450 during the cutting stroke, the cutting tool T cams over the ramp surface 454, thereby changing the orientation of the cutting tool T relative to the cable 12, 400 without any conscious determination made by the user. Camming the cutting tool T over the ramp surface 454 causes the cutting tool blade to exit the cable sooner compared to a cutting stroke without the ramp members 450. Causing the blade to exit the cable sooner shortens the length of the window cut 19, 20 (e.g., see FIG. 22). Installing the ramp members 450 at the first base section 442 may cause the cutting tool T to enter the cable 12, 400 at a location further along the cable 12, 400, thereby shorting the window cut 19, 20.

In other implementations, the guide tool 420 may have an adjustable length to allow a user to pre-select a length for the window cut 19, 20. For example, the guide tool 420 may include two telescoping parts to increase or decrease a length of the platform section 444. In still other implementations, the guide tool 420 may include telescoping parts to increase or decrease a length of the base sections 442 (or to increase or decrease the distance X2) to modify the angle of the cable 12, 400 at the first axial end of the platform section 444. Accordingly, changing the distance X2 modifies the predetermined angle at which the cutting tool blade will enter the cable 12, 400.

FIGS. 23-31 illustrate another example cutting tool 500 for use in making a window cut 19, 20 in a cable 12, 400. The cutting tool 500 includes a sleigh 502 defining a guide channel 506. The guide channel 506 extends between a front 501 and a rear 503 of the cutting tool 500. The guide channel 506 is sized to receive a portion of a cable 12, 400. A handle 504 is coupled to the sleigh 502 to enable a user to move the cutting tool 500 along a cable 12, 400. The sleight 502 defines a bottom 505 of the tool 500 and the handle 504 defines a top 507 of the tool 500. In certain examples, the handle 504 may include a contoured grip section 512.

The sleigh 502 carries a blade 520 to cut a jacket 406 of the cable 12, 400. The sleigh 502 defines a cavity 515 in which a blade 520 is disposed. A first aperture 508 extends between the cavity 515 and the guide channel 506. An edge 522 of the blade 520 is disposed at the first aperture 508. A second aperture 510 provides access to the cavity 515 from an exterior of the tool 500 at the rear 503 of the tool 500.

In use, the cutting tool 500 is positioned over the cable 12, 400 so that the cable extends through the guide channel 506. A user pushes or pulls the handle 504 to move (e.g., slide) the tool 500 forwardly along the cable 12, 400. The blade edge 522 cuts into the jacket 406 of the cable 12, 400 through the first aperture 508. The blade 520 separates the cable jacket 406 into a portion that remains on the cable 12, 400 and a scrap portion that is removed from the cable. The scrap portion exits the tool 500 through the second aperture 510.

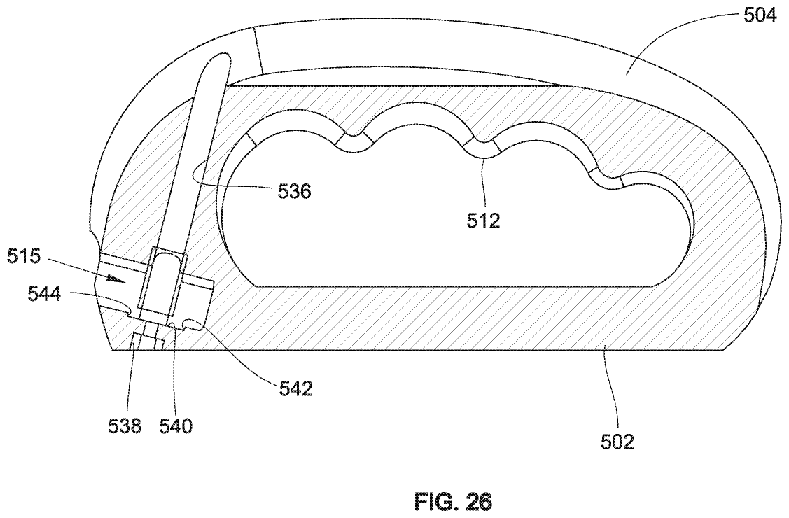

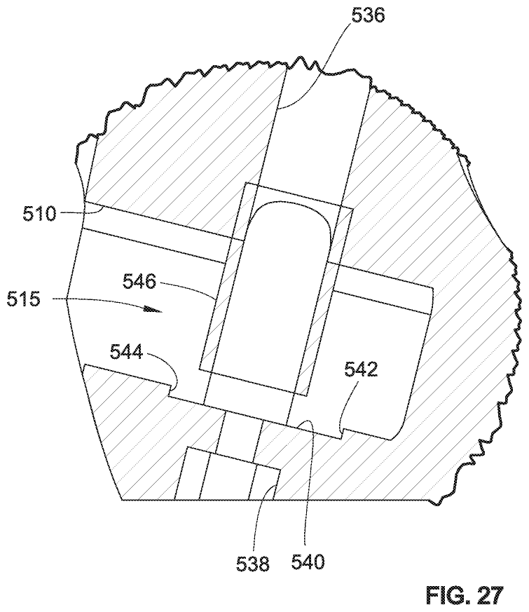

The cavity 515 is configured to hold the blade 520 at a fixed position and orientation relative to the guide channel 506. In certain implementations, the cavity 515 has a recessed surface 540 on which the blade 520 seats. As shown in FIGS. 26 and 27, the recessed surface 540 is bounded at a first end by a rearward-facing shoulder 542 and is bounded at a second end by a forward-facing shoulder 544. Abutment between the cutting edge 522 of the blade 520 and the rearward-facing shoulder 542 inhibits the blade 520 from forward movement within the cavity 515 once installed at the recessed surface 540. Abutment between an opposite edge 524 of the blade 520 and the forward-facing shoulder 544 inhibits the blade 520 from rearward movement within the cavity 515 once installed at the recessed surface 540.

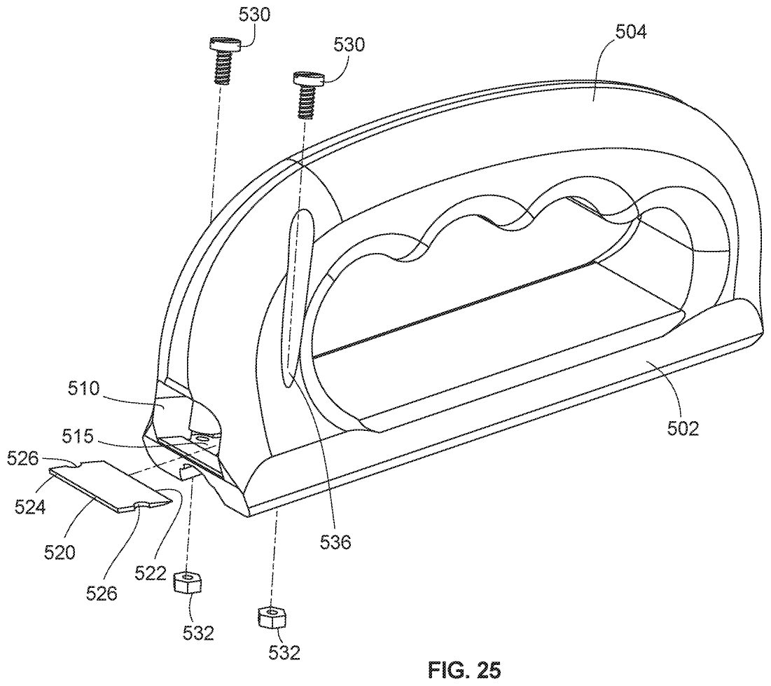

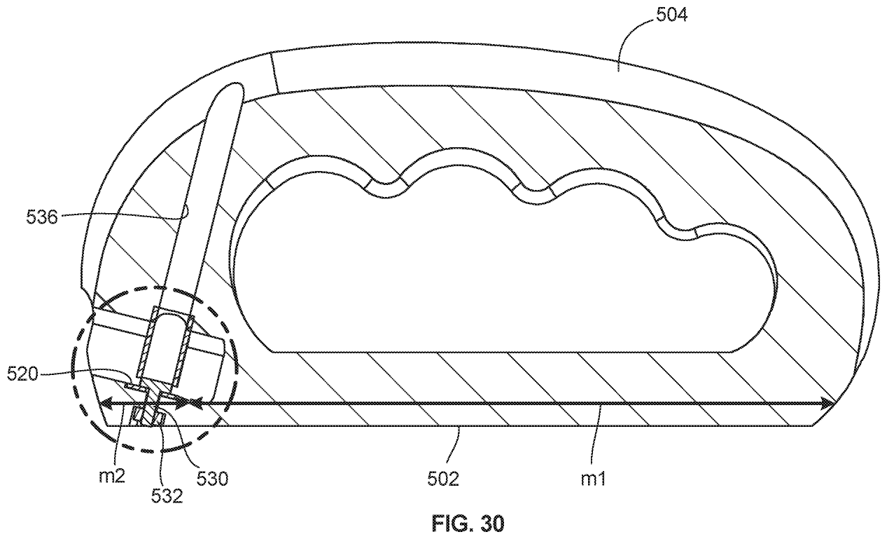

In certain implementations, the blade 520 is releasably held within the cavity 515. Accordingly, the blade 520 can be replaced when worn or damaged. The blade 520 is inserted into and/or removed from the tool 500 through the second aperture 510. In certain examples, the blade 520 is held within the cavity 515 using fasteners 530. As shown in FIG. 25, sides of the blade 520 may define notches 526 or fastener openings through which the fasteners 530 may extend when installed. Accordingly, the fasteners 530 inhibit sideways movement of the blade 520 within the cavity 515. In certain examples, heads 531 of the fasteners may press down on the blade 520 to further hold the blade 520 in place within the cavity 515 (e.g., see FIG. 29).

As shown in FIGS. 26 and 27, the cutting tool 500 defines fastener guide openings 536 through which the fasteners 530 are installed. For example, the fastener guide openings 536 extend through the handle 504. A guide member 546 extends each fastener guide opening 536 into the cavity 515. The sleigh 502 defines pockets 538 in which nuts 532 seat to secure the fasteners 530. The pockets 538 are aligned with the guide members 546 to align the fasteners 530 inserted through the guide members 546 with the nuts 532 held in the pockets 538.

In certain implementations, the fasteners 530 include screws. In certain examples, the pockets 538 are shaped to hold the nuts 532 in non-rotatable positions within the pockets 538. Accordingly, a user need not hold the nuts 532 while screwing in the fasteners 530. In the example shown, the pockets 538 have a hexagonal shape. In other examples, the pockets 538 may otherwise correspond with the shape of the nuts 532. In certain examples, the pockets 538 are sized so that the nuts 532 friction-fit within the pockets 538. Accordingly, even when the fasteners 530 are removed (e.g., to change the blade 520), the nuts 532 stay within the pockets 538.

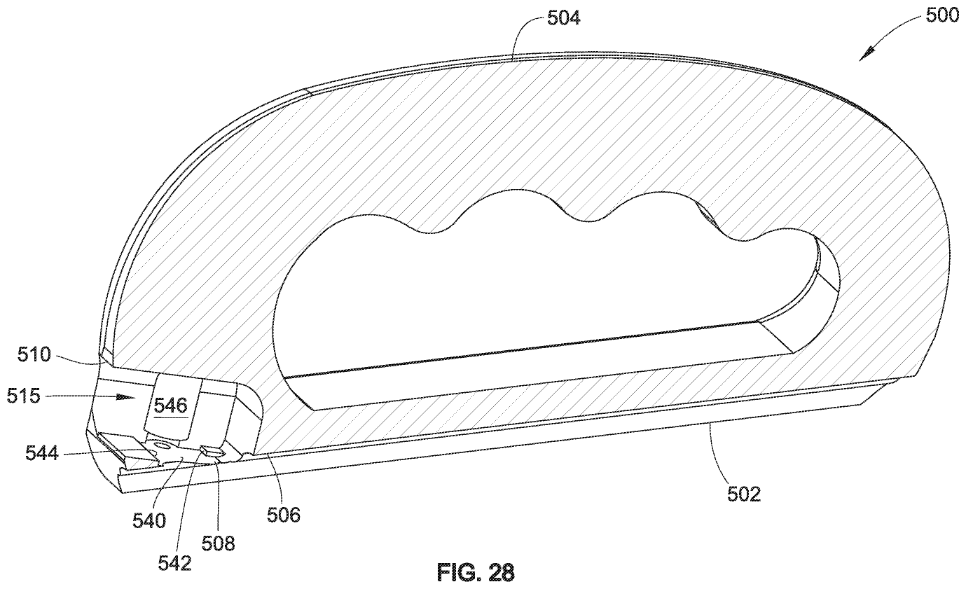

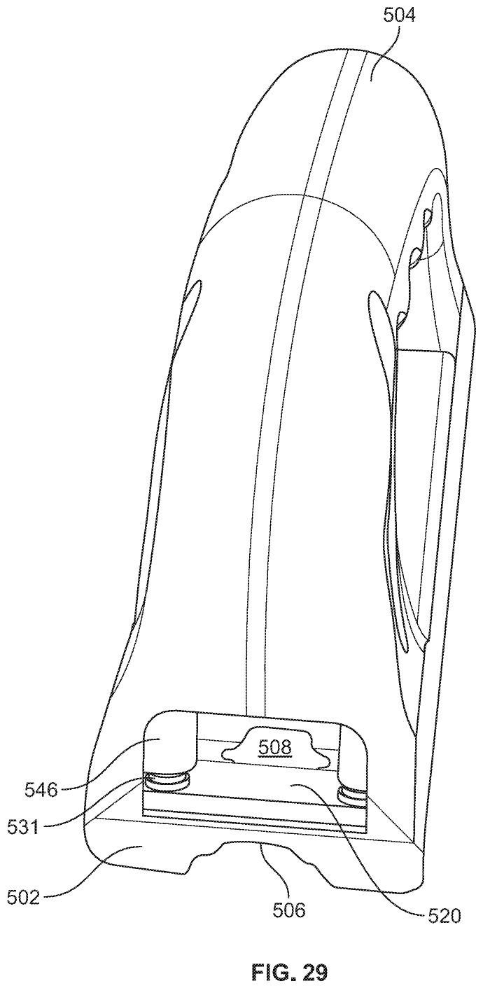

As shown in FIGS. 28-31, the blade 520 is held at a predetermined position and orientation relative to the cable guide channel 506. The blade 520 is angled relative to the guide channel 506. Accordingly, when the tool 500 is first positioned over the cable 12, 400, the blade edge 522 is angled relative to the cable jacket 406. Initial movement of the tool 500 along the cable 12, 400 causes the blade edge 522 to cut into the cable jacket 406. However, engagement between the cable 12, 400 and the guide channel 506 and the fixed position between the blade 520 and the guide channel 506 inhibit cutting of the blade 520 into the jacket 406 beyond a predetermined depth. Rather, continued movement of the tool 500 along the cable 12, 400 moves the blade edge 522 in a relatively straight line along the cable jacket 406, thereby making the window cut 19, 20. To end the window cut 19, 20, a user angles the cutting tool 500 away from the cable 12, 400 and pulls the tool 500 away from the cable 12, 400.

Accordingly, a window cut 19, 20 can be easily made by a user without risking cutting the fibers 402 within the cable 12, 400. The cutting tool 500 limits the depth of the initial insertion cut to a predetermined depth and maintains the blade edge 522 at the predetermined depth throughout the cutting stroke. The blade 520 is disposed at the rear 503 of the tool. Therefore, the guide channel 506 extends a first distance M1 between the blade edge 522 at the front 501 of the tool 500 and extends a second distance M2 between the blade edge 522 and the rear 503 of the tool 500.

The first distance M1 is larger than the second distance M2. Accordingly, engagement between the cable 12, 400 and the first distance M1 of the guide channel 506 inhibits rotation of the tool 500 that would angle the blade edge 522 deeper into the cable 12, 400. However, the engagement between the cable 12, 400 and the second distance M2 of the guide channel 506 allows rotation of the tool 500 that lifts the blade edge 522 away from the cable 12, 400. In certain examples, the first distance M1 is at least twice the second distance M2. In certain examples, the first distance M1 is at least three times the second distance M2. In certain examples, the first distance is at least four times the second distance M2. In certain examples, the first distance is at least six times the second distance M2. In certain examples, the first distance is at least ten times the second distance M2.

As shown in FIG. 28, the recessed surface 540 is angled relative to the cable guide channel 506. Accordingly, the blade 520 is held at a fixed angle relative to the cable guide channel 506. The first aperture 508 is positioned along the guide channel 506 to allow a small section of the cable 12, 400 to enter the cavity 515 as the tool 500 is moved over the cable 12, 400. This small section of the cable 12, 400 slides against the edge 522 of the blade 520, thereby allowing the blade 520 to cut the jacket 406 from the cable 12, 400. The recessed surface 540 also holds the blade 520 at a fixed height relative to the guide channel 506. Accordingly, the blade 520 cannot be pressed too deeply into the cable jacket 406 (e.g., cannot be pressed sufficiently deep to cut the fibers 402).

In certain examples, the tool 500 holds the blade 520 at an angle of between 5° and 25° relative to a longitudinal axis of the cable guide channel 506. In certain examples, the tool 500 holds the blade 520 at an angle of between 10° and 20° relative to a longitudinal axis of the cable guide channel 506. In an example, the tool 500 holds the blade 520 at an angle of 12° relative to a longitudinal axis of the cable guide channel 506. In an example, the tool 500 holds the blade 520 at an angle of 14° relative to a longitudinal axis of the cable guide channel 506. In an example, the tool 500 holds the blade 520 at an angle of 15° relative to a longitudinal axis of the cable guide channel 506. In an example, the tool 500 holds the blade 520 at an angle of 16° relative to a longitudinal axis of the cable guide channel 506. In an example, the tool 500 holds the blade 520 at an angle of 18° relative to a longitudinal axis of the cable guide channel 506.

In certain examples, the tool 500 holds the blade 520 at a fixed height of between 0 mm and 10 mm. In certain examples, the tool 500 holds the blade 520 at a fixed height of between 0 mm and 8 mm. In certain examples, the tool 500 holds the blade 520 at a fixed height of between 0 mm and 5 mm. In certain examples, the tool 500 holds the blade 520 at a fixed height of between 1 mm and 10 mm. In certain examples, the tool 500 holds the blade 520 at a fixed height of between 1 mm and 5 mm. In an example, the tool 500 holds the blade 520 at a fixed height of 1 mm below the top of the guide channel 506. In an example, the tool 500 holds the blade 520 at a fixed height of 2 mm below the top of the guide channel 506. In an example, the tool 500 holds the blade 520 at a fixed height of 3 mm below the top of the guide channel 506. In an example, the tool 500 holds the blade 520 at a fixed height of 4 mm below the top of the guide channel 506. In an example, the tool 500 holds the blade 520 at a fixed height of 5 mm below the top of the guide channel 506.

In an example, the tool 500 holds the blade at an angle of 10° and a distance of 1 mm. In an example, the tool 500 holds the blade at an angle of 14° and a distance of 1 mm. In an example, the tool 500 holds the blade at an angle of 18° and a distance of 1 mm. In an example, the tool 500 holds the blade at an angle of 10° and a distance of 2 mm. In an example, the tool 500 holds the blade at an angle of 14° and a distance of 2 mm. In an example, the tool 500 holds the blade at an angle of 18° and a distance of 2 mm. In an example, the tool 500 holds the blade at an angle of 10° and a distance of 4 mm. In an example, the tool 500 holds the blade at an angle of 14° and a distance of 4 mm. In an example, the tool 500 holds the blade at an angle of 18° and a distance of 4 mm.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

1. A cutting tool for making a window cut within a jacket of a telecommunications cable, the cutting tool comprising:
a handle having a handle length that extends between a first handle end and an opposite second handle end;
a cutting head integrated with the first end of the handle, the cutting head defining a first cable-receiving channel having an open side that faces downwardly away from the handle, the first cable-receiving channel having a channel length that extends along a channel axis between open first and second opposite channel ends of the first cable-receiving channel, the channel length extending in an orientation along the handle length with the first channel end being closer to the second handle end than the second channel end, the cutting head including first, second and third guide surfaces positioned within the first cable receiving channel that face generally downwardly, the first guide surface being positioned adjacent the first channel end, the second guide surface being positioned adjacent the second channel end, and the third guide surface being positioned between the first and second guide surfaces, the first guide surface angling upwardly from the third guide surface as the first guide surface extends away from the third guide surface and toward the second handle end, and the second guide surface angling upwardly from the third guide surface as the second guide surface extends away from the third guide surface and away from the second handle end; and
a blade that mounts within the first cable-receiving channel at a blade mounting location positioned adjacent the third guide surface, wherein the blade is oriented parallel to an angular orientation of the third guide surface when the blade is mounted at the blade mounting location, and wherein a cutting edge of the blade faces generally toward the second handle end when the blade is mounted at the blade mounting location.

2. The cutting tool of claim 1, further comprising a second cable-receiving channel integrated with the second handle end.

3. The cutting tool of claim 2, wherein the first cable-receiving channel, the second cable-receiving channel and the handle are bisected by a common reference plane.

4. The cutting tool of claim 2, wherein the second cable-receiving channel includes a cable contact surface that aligns with the first guide surface.

5. The cutting tool of claim 1, wherein the cutting edge of the blade is positioned relative to the first guide surface such that the first guide surface controls a cutting depth of the cutting edge into the jacket of the cable.

6. A method for using the cutting tool of claim 1, the method comprising:
moving the blade into the cable jacket until the first guide surface contacts the cable jacket such that the first guide surface controls a cutting depth of an initial entrance cut the blade into the cable jacket;
after the blade is initially moved into the jacket to the cutting depth corresponding to the initial entrance cut, pivoting the handle away from the cable to bring the third guide surface into a parallel, contacting relationship relative to the cable jacket;
once the third guide surface is in the parallel, contacting relationship with respect to the cable jacket, sliding the cutting tool straight along the cable such that the blade makes a widow cut along a section of the cable jacket; and
once the window cut has been made, further pivoting the handle away from the cable jacket such that the blade makes an exit cut from the cable jacket.

7. A cutting tool for making a window cut within a jacket of a cable, the cutting tool comprising:
a body defining a cable guide channel extending between a front and a rear of the body, the body carrying a blade at a fixed angle and a fixed height relative to the cable guide channel, the cable guide channel having a first section extending from the blade to the front of the body and a second section extending from the blade to the rear of the body, the first section being substantially larger than the second section.

8. The cutting tool of claim 7, wherein the fixed angle is between 10° and 20°.

9. The cutting tool of claim 7, wherein the fixed height is between 0 mm and 5 mm.

10. The cutting tool of claim 7, wherein the blade is releasably mounted to the body using fasteners.

11. The cutting tool of claim 10, wherein the body defines pockets for receiving nuts for the fasteners.

12. The cutting tool of claim 11, wherein the pockets hold the nuts in non-rotational positions.

13. The cutting tool of claim 10, wherein the blade is held within a cavity defined in the body, wherein a first aperture extends between the cavity and the guide channel, and wherein a second aperture extends between the cavity an the rear of the body.

14. The cutting tool of claim 7, wherein the blade is held at a fixed axial position within the body.

15. A guide tool for making a window cut within a jacket of a cable, the guide tool comprising:
a body defining a platform section disposed between two base sections, the platform section including a guide channel, each base section including a retention member, the platform section being disposed sufficiently far above the base section and sufficiently far from the retention members to bend a cable received at the body along a cutting path.

16. The guide tool of claim 15, wherein each retention member defines a slot in which to receive the cable.

17. The guide tool of claim 15, wherein each retention member is configured to inhibit rotation of the cable.

18. The guide tool of claim 15, wherein sidewalls are disposed at opposite sides of the guide channel.

19. The guide tool of claim 15, wherein the body extends between opposite sides and between opposite ends, each of the opposite ends being defined by a respective one of the base sections, wherein at least one of the opposite sides of the body is tapered.

20. The guide tool of claim 15, further comprising a ramp member configured to be selectively installed at one of the base sections of the body, the ramp member having a shorter side at a common height with the platform section and a taller side that is higher than the platform section.
